(19) United States
(12) Patent Application Publication
(10) Pub. No.: US 2022/0330215 A1
(43) Pub. Date: Oct. 13, 2022

(54) METHOD OF SEARCH SPACE MONITORING AND USER EQUIPMENT USING THE SAME

(71) Applicant: FG Innovation Company Limited, New Territories (HK)

(72) Inventors: Chia-Hsin Lai, Taipei City (TW); Hsin-Hsi Tsai, Taipei City (TW); Hai-Han Wang, Taipei City (TW)

(73) Assignee: FG Innovation Company Limited, New Territories (HK)

(21) Appl. No.: 17/709,400

(22) Filed: Mar. 30, 2022

Related U.S. Application Data
(60) Provisional application No. 63/172,578, filed on Apr. 8, 2021.

(51) Int. Cl. H04W 72/04; H04W 76/19; H04W 74/08

(52) U.S. Cl. CPC H04W 72/042; H04W 76/19; H04W 74/0833

(57) ABSTRACT

A method and a user equipment of search space monitoring are provided. The method includes: receiving first configured information corresponding to a plurality of search space set groups, wherein a number of the plurality of search space set groups is greater than two; receiving a downlink control information (DCI) which includes a DCI field with a value indicating a first search space set group in the plurality of search space set groups according to the first configured information; and monitoring for a physical downlink control channel in a search space set in response to the search space set being included in the first search space set group.

### CROSS-REFERENCE TO RELATED APPLICATION

The present application claims the benefit of and priority to U.S. Provisional Patent Application Ser. No. 63/172,578, filed on Apr. 8, 2021, entitled “METHOD AND APPARATUS TO SUPPORT SPECIAL SEARCH SPACE SET GROUP FOR POWER SAVING” with Attorney Docket No. US84738, the content of which is hereby incorporated fully by the reference herein into the present disclosure.

### BACKGROUND

### Technical Field

The present disclosure generally relates to wireless communication, and more particularly, a method of search space monitoring and a user equipment (UE) using the same method.

### Description of Related Art

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

A UE power saving work item description (WID) is agreed in 3GPP specification RP-193239, specifying that enhancements on power saving techniques for a connected-mode UE is needed so as to minimize system performance impact to RAN1 or RAN4.

### SUMMARY

The present disclosure is directed to a method of search space monitoring and a UE using the same method.

The disclosure provides a method of search space monitoring, adapted to a user equipment, wherein the method comprising: receiving first configured information corresponding to a plurality of search space set groups, wherein a number of the plurality of search space set groups is greater than two; receiving a downlink control information (DCI) which includes a DCI field with a value indicating a first search space set group in the plurality of search space set groups according to the first configured information; and monitoring for a physical downlink control channel in a search space set in response to the search space set being included in the first search space set group.

In one embodiment of the disclosure, one of the plurality of search space set groups includes no search space set or no monitoring occasion.

In one embodiment of the disclosure, the method further comprising: stopping monitoring for the physical downlink control channel in the search space set in response to no search space set or no monitoring occasion being included in the first search space set group.

In one embodiment of the disclosure, the step of stopping monitoring for the physical downlink control channel in the search space set in response to no search space set or no monitoring occasion being included in the first search space set group comprising: stopping monitoring for the physical downlink control channel in the search space set in response to an event not occurring, wherein the event comprises one of a scheduling request, a random access procedure, and a beam failure recovery procedure.

In one embodiment of the disclosure, the method further comprising: monitoring a default search space set according to the value in response to no search space set being included in the first search space set group.

In one embodiment of the disclosure, the step of monitoring the default search space set according to the value in response to no search space set being included in the first search space set group comprising: monitoring the default search space set in response to an event occurring, wherein the event comprises one of a scheduling request, a random access procedure, and a beam failure recovery procedure.

In one embodiment of the disclosure, the method further comprising: receiving second configured information corresponding to a timer; and monitoring for the physical downlink control channel in the search space set while the timer is running.

In one embodiment of the disclosure, the method further comprising: starting monitoring for the physical downlink control channel in a default search space set after the timer expiring.

In one embodiment of the disclosure, a format of the downlink control information comprises one of downlink control information 0_1, downlink control information 0_2, downlink control information 1_1, and downlink control information 1_2.

In one embodiment of the disclosure, the downlink control information further includes a number of search space set groups.

The disclosure provides a user equipment, comprising: one or more non-transitory computer-readable media having computer-executable instructions embodied thereon; and at least one processor coupled to the one or more non-transitory computer-readable media, and configured to execute the computer-executable instructions to: receive first configured information corresponding to a plurality of search space set groups, wherein a number of the plurality of search space set groups is greater than two; receive a downlink control information (DCI) which includes a DCI field with a value indicating a first search space set group in the plurality of search space set groups according to the first configured information; and monitor for a physical downlink control channel in a search space set in response to the search space set being included in the first search space set group.

In one embodiment of the disclosure, one of the plurality of search space set groups includes no search space set or no monitoring occasion.

In one embodiment of the disclosure, the at least one processor further configured to execute the computer-executable instructions to: stop monitoring for the physical downlink control channel in the search space set in response to no search space set or no monitoring occasion being included in the first search space set group.

In one embodiment of the disclosure, the at least one processor further configured to execute the computer-executable instructions to: stop monitoring for the physical downlink control channel in the search space set in response to an event not occurring, wherein the event comprises one of a scheduling request, a random access procedure, and a beam failure recovery procedure.

In one embodiment of the disclosure, the at least one processor further configured to execute the computer-executable instructions to: monitor a default search space set according to the value in response to no search space set being included in the first search space set group.

In one embodiment of the disclosure, the at least one processor further configured to execute the computer-executable instructions to: monitor the default search space set in response to an event occurring, wherein the event comprises one of a scheduling request, a random access procedure, and a beam failure recovery procedure.

In one embodiment of the disclosure, the at least one processor further configured to execute the computer-executable instructions to: receive second configured information corresponding to a timer; and monitor for the physical downlink control channel in the search space set while the timer is running.

In one embodiment of the disclosure, the at least one processor further configured to execute the computer-executable instructions to: start monitoring for the physical downlink control channel in a default search space set after the timer expiring.

In one embodiment of the disclosure, a format of the downlink control information comprises one of downlink control information 0_1, downlink control information 0_2, downlink control information 1_1, and downlink control information 1_2.

In one embodiment of the disclosure, the downlink control information further includes a number of search space set groups.

In view of the foregoing, the present disclosure provides a DCI-based power saving method during DRX Active Time for an active BWP, wherein the method may reduce PDCCH monitoring efforts for the UE in the connected-mode.

To make the aforementioned more comprehensible, several embodiments accompanied with drawings are described in detail as follows.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 illustrates a schematic diagram of a DRX cycle according to an embodiment of the present disclosure.

FIG. 2 illustrates a schematic diagram of an explicit search space switching mechanism according to an embodiment of the present disclosure.

FIG. 3 illustrates a schematic diagram of an implicit search space switching mechanism according to an embodiment of the present disclosure.

FIG. 4 illustrates a schematic diagram of PDCCH monitoring occasions identified by SearchSpace and CORESET according to an embodiment of the present disclosure.

FIG. 5 illustrates a PDCCH skipping scheme according to an embodiment of the present disclosure.

FIG. 6 illustrates a schematic diagram of DCP operation with wake-up indication according to an embodiment of the present disclosure.

FIG. 7 illustrates a block diagram of a node for wireless communication according to an embodiment of the present disclosure.

FIG. 8 illustrates a flowchart of a method of search space monitoring according to an embodiment of the present disclosure.

### DESCRIPTION OF THE EMBODIMENTS

The acronyms in the present disclosure are defined as follows and unless otherwise specified, the acronyms have the following meanings:

Acronym Full name
3GPP 3^{rd} Generation Partnership Project
5GC 5G Core
ACK Acknowledgement
ARQ Automatic Repeat Request
BA Bandwidth Adaptation
BS Base Station
BSR Buffer Status Report
BWP Bandwidth Part
CA Carrier Aggregation
CCCH Common Control Channel
CE Control Element
CH Channel
CN Core Network
CORESET Control Resource Set
C-RNTI Cell-Radio Network Temporary Identifier
CSS Common Search Space
DC Dual Connectivity
DCI Downlink Control Information
DCP DCI with CRC scrambled by PS-RNTI
DL Downlink
DRX Discontinuous Reception
HARQ Hybrid Automatic Repeat Request
ID Identification
IE Information Element
LBT Listen Before Talk
LSB Least Significant Bit
MAC Medium Access Control
MCG Master Cell Group
MIMO Multiple Input Multiple Output
MSB Most significant Bit
NG-RAN Next-Generation Radio Access Network
NR New Radio
NR-U New Radio Unlicensed
NW Network
PCell Primary Cell
PDCCH Physical Downlink Control Channel
PDCP Packet Data Convergence Protocol
PDSCH Physical Downlink Shared Channel
PDU Protocol Data Unit
PHR Power Headroom Report
PHY Physical Layer
PRACH Physical Random Access Channel
PUCCH Physical Uplink Control Channel
PUSCH Physical Uplink Shared Channel
RA Random Access
RACH Random Access Channel
RAN Radio Access Network
RAR Random Access Response
Rel Release
RLC Radio Link Control
RNTI Radio Network Temporary Identifier
RRC Radio Resource Control
SCell Secondary Cell
SCG Secondary Cell Group
SCS Sub Carrier Spacing
SDAP Service Data Adaptation Protocol
SDU Service Data Unit
SFN System Frame Number
SI System Information
SL Sidelink
SPS Semi-Persistent Scheduling
SR Scheduling Request
SS Search Space
SSSG Search Space Set Group
TS Technical Specification
UCI Uplink Control Information
UE User Equipment
UL Uplink
USS UE-specific search space

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A UE may be referred to as PHY/MAC/RLC/PDCP/SDAP entity. The PHY/MAC/RLC/PDCP/SDAP entity may be referred to as the UE.

A network (NW) may be a network node, a transmission/reception point (TRP), a cell (e.g., SpCell, PCell, PSCell, and/or SCell), an eNB, a gNB, and/or a base station.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells. A serving cell may refer to a PCell, a PSCell, or an SCell. The serving cell may be an activated or a deactivated serving. For Dual Connectivity operation, the term Special Cell may refer to the PCell of the MCG or the PSCell of the SCG depending on if the MAC entity is associated to the MCG or the SCG, respectively. Otherwise, the term Special Cell may refer to the PCell. A Special Cell may support PUCCH transmission and contention-based Random Access, and is always activated.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

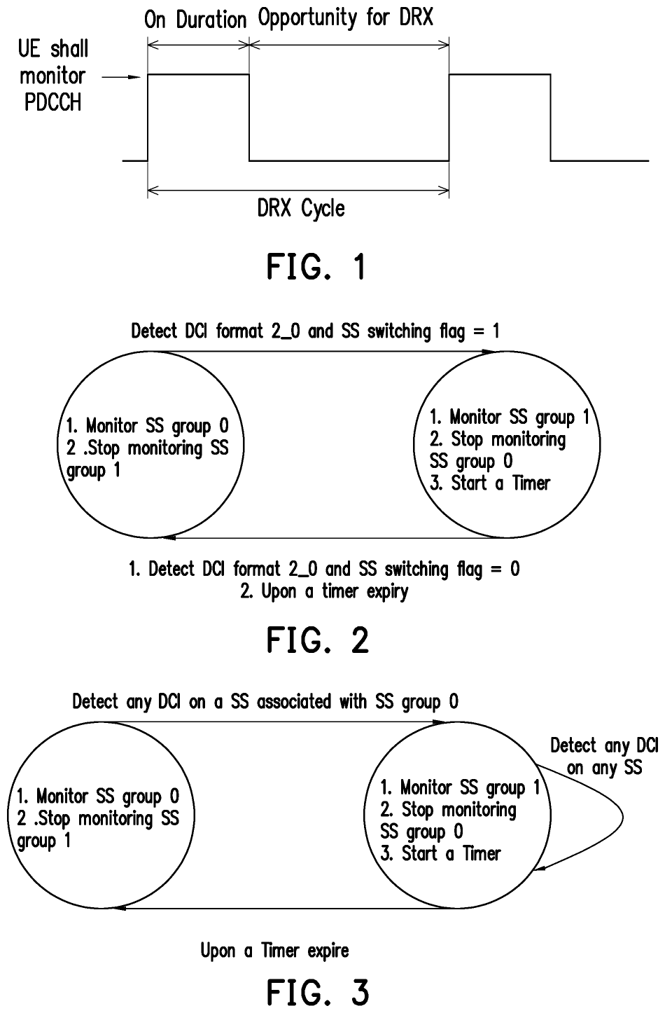

With regard to UE Power Saving, the PDCCH monitoring activity of the UE in RRC connected mode may be governed by DRX, BA, and DCP, etc. When DRX is configured, the UE does not have to continuously monitor PDCCH. DRX is characterized by parameters including (DRX) on-duration, (DRX) inactivity-timer, (DRX) retransmission-timer, (DRX) cycle, and (DRX) active time. (DRX) on-duration is a duration that the UE waits for, after waking up, to receive PDCCH(s). If the UE successfully decodes a PDCCH, the UE may stay awake and start the inactivity timer. (DRX) inactivity-timer is a duration that the UE waits, from the last successful decoding of a PDCCH, to successfully decode a PDCCH. If the UE fails to decode the PDCCH, the UE may go back to sleep. The UE shall restart the inactivity timer following a single successful decoding of a PDCCH for a first transmission only (i.e. not for retransmissions). (DRX) retransmission-timer is a duration until a retransmission can be expected. (DRX) cycle specifies the periodic repetition of the on-duration followed by a possible period of inactivity. (DRX) active time is a total duration that the UE monitors for PDCCH(s). Active time may include the “on-duration” of the DRX cycle (as shown in FIG. 1), the time UE is performing continuous reception while the inactivity timer has not expired, and the time when the UE is performing continuous reception while waiting for a retransmission opportunity.

When BA is configured for the UE, the UE only has to monitor for PDCCH(s) on one active BWP. That is, the UE does not have to monitor for PDCCH(s) on the entire DL frequency of the cell. A BWP inactivity timer (independent from the DRX inactivity-timer described above) may be used to switch the active BWP to the default BWP. Specifically, the BWP inactivity timer may be restarted upon a successful PDCCH decoding. When the BWP inactivity timer expires, the active BWP for the UE may switch to the default BWP.

In addition, the UE may be indicated, when configured accordingly, whether the UE is required to monitor for the PDCCH(s) during the next occurrence of the DRX on-duration by a DCP, wherein the DCP may be detected by the UE on the active BWP. If the UE does not detect a DCP on the active BWP, the UE may not monitor for the PDCCH(s) during the next occurrence of the DRX on-duration, unless the UE is explicitly configured to do so in that case. A UE may be configured to monitor the DCP only when the connected-mode DRX is configured, and the UE may monitor the DCP at occasion(s) a configured offset before the on-duration.

One or more monitoring occasions can be configured before the on-duration. The UE may not monitor the DCP on the occasions occurring during active-time, measurement gaps, or BWP switching, in which case the UE may monitor for the PDCCH(s) during the next on-duration. If no DCP is configured in the active BWP, UE may follow normal DRX operation. When CA is configured, DCP is only configured on the PCell. One DCP can be configured to control PDCCH monitoring during on-duration for one or more UEs independently.

Power saving in RRC_IDLE and RRC_INACTIVE can be achieved by UE relaxing neighbour cells radio resource management (RRM) measurements when the UE meets the criteria determining that the UE is in low mobility and/or not at cell edge. UE power saving may be enabled by adapting the DL maximum number of MIMO layers by BWP switching. Power saving may also be enabled during active-time via cross-slot scheduling, wherein the cross-slot scheduling may facilitate the UE to achieve power saving with the assumption that the UE won't be scheduled to receive PDSCH, be triggered to receive A-CSI, or transmit a PUSCH scheduled by the PDCCH(s) until the minimum scheduling offset K0 or K2. Dynamic adaptation of the minimum scheduling offsets K0 or K2 may be controlled by PDCCH(s).

With regard to Dynamic search space (SS) adaption, in Rel-16 NR-U, SS set group switching was introduced by which UE can be configured to switch between sparse and frequent PDCCH monitoring. There are two switching mechanisms for SS set group switching (i.e., by an explicit indication or by a timer).

The first switching mechanism is the explicit SS switching. An explicit switching of two SS groups may be done through the detection of DCI format 2_0. The UE may be configured with the RRC parameter searchSpaceSwitchTrigger-r16. Each SearchSpaceSwitchingTrigger object provides a position in DCI format 2_0 of the bit field indicating a search space switching flag for a serving cell or, if CellGroupsForSwitching-r16 is configured, a group of serving cells. In one embodiment, the bit value “0” of the search space switching flag indicates the first SS group (e.g., SS group 0) to be monitored and the bit value “1” of the search space switching flag indicates the second SS group (e.g., SS group 1) to be monitored. The explicit switching mechanism is shown in FIG. 2. The details of the explicit SS switching mechanism could be found in 3GPP TS 38.331 V16.1.0.

In one embodiment, the SS switching may be performed implicitly. An implicit SS switching may happen when the UE is not configured with RRC parameter searchSpaceSwitchTrigger-r16. There are two ways for performing the implicit SS switching, one is via a DCI (not limited to DCI format 2_0) and the other one is via a timer as represented in FIG. 3. The details of the implicit SS switching mechanism could be found in 3GPP TS 38.331 V16.1.0.

The second switching mechanism is the timer-based SS switching. A timer (e.g., searchSpaceSwitchingTimer) may be configured to the UE for SS switching. For example, the UE may (re-)start the timer when the UE detects the DCI (e.g., DCI format 2_0) and the SS switching flag in the DCI is set to “1”, when the UE detects any DCI on a SS associated with SS group 0, and/or when the UE detects any DCI on any SS. Upon the timer expires, the UE may switch the SS to SS group 0 (e.g., to monitor SS group 0 and stop monitoring SS group 1). The timer-based SS switching may be applied to both explicit SS switching and implicit SS switching as shown in FIG. 2 and FIG. 3. The details of the timer-based SS switching could be found in 3GPP TS 38.331 V16.1.0.

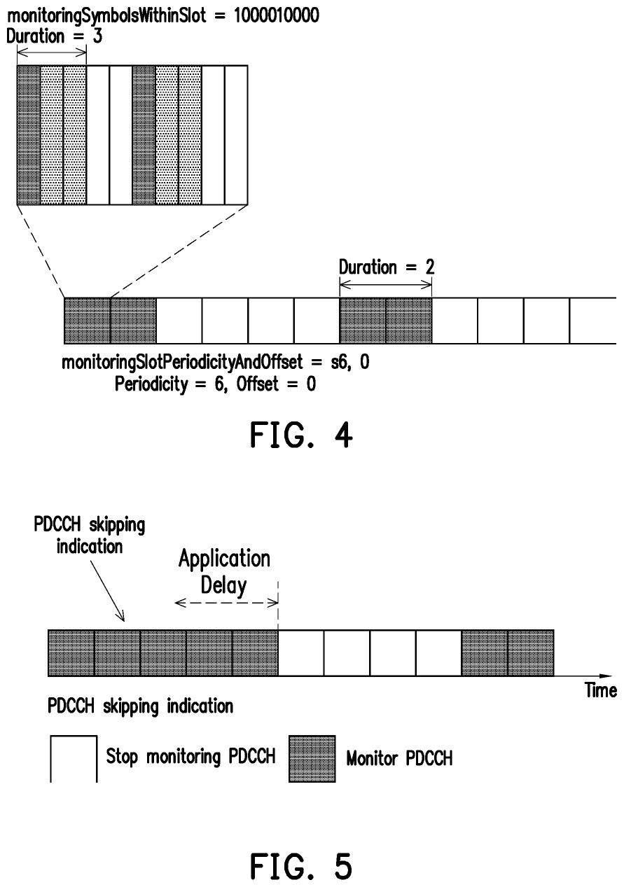

With regard to search space configuration parameters, in NR, basically the monitoringSlotPeriodicityAndOffset and duration in SearchSpace decide the slots where the PDCCH is monitored, and the monitoringSymbolsWithinSlot in SearchSpace and duration in ControlResourceSet determine the PDCCH monitoring occasion pattern within a slot, as shown in FIG. 4.

FIG. 5 illustrates a PDCCH skipping scheme according to an embodiment of the present disclosure. The UE may receive a PDCCH skipping indication (containing/carrying a specific DCI format) from the NW. The PDCCH skipping indication may be used to indicate a duration that the UE may need to stop monitoring for PDCCH(s). The UE may start to apply the PDCCH skipping indication after a time period of application delay. After the duration for stopping monitoring for PDCCH(s), the UE may restart monitoring for PDCCH(s) as usual (e.g., when the UE is in DRX active time). The NW may preconfigure one or more durations for stopping monitoring for PDCCH(s) via the higher layer parameter (e.g., RRC configuration). After that, the PDCCH skipping indication may be transmitted to the UE so as to indicate which duration should be applied for PDCCH skipping.

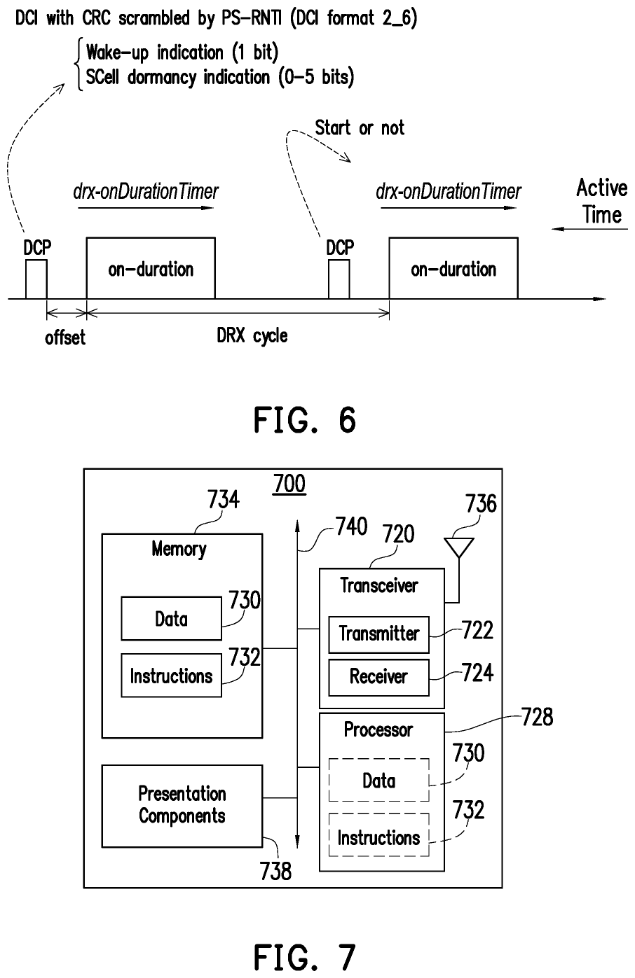

With regard to DCP, Rel-16 introduced a new physical layer signalling which could be used to further control the PDCCH monitoring behavior for the on-duration based on the configured DRX mechanism. The NW could send the new physical layer signalling to the UE to ask the UE to/not to wake up within DRX on-duration. The new physical layer signalling is called DCI with CRC scrambled by PS-RNTI (DCP). FIG. 6 illustrates a schematic diagram of DCP operation with wake-up indication according to an embodiment of the present disclosure.

DCP is indicated by DCI format 2_6, which is used for notifying the power saving information outside DRX Active Time for one or more UEs. The DCI format 2_6 includes two indications: one is “Wake-up indication” (1 bit), and the other is “Dormancy indication” (0-5 bits). The “Wake-up indication” is used to control the PDCCH monitoring behavior for the on-duration of DRX, which is the indication introduced above. The “Dormancy indication” is used to control the BWP switching (i.e., entering or leaving a dormant BWP) for a dormancy SCell group.

When it comes to BWP switching for the serving cell(s) of a dormancy group, the NW could group one or more serving cells (e.g., SCells) into a dormancy group and could configure one or more dormancy groups. The dormancy group configuration may be indicated by the IE dormancyGroupWithinActiveTime and/or the IE dormancyGroupOutsideActiveTime (in ServingCellConfig). The IE dormancyGroupWithinActiveTime or the IE dormancyGroupOutsideActiveTime may contain the ID of a dormancy group within active time/outside active time, to which the serving cell belongs. In addition, the number of groups could be configured for a Cell Group may be determined according to an IE maxNrofDormancyGroups). Upon dormancy group(s) is configured, the NW could switch the BWPs for all the serving cells in the dormancy group(s) entering/leaving dormant BWP via a signalling (e.g., DCI format 26, DCI format 0_1, DCI format 1_1, etc.).

According to the discussion in Rel-17 power saving, striving a common design for DCI based PDCCH monitoring adaptation in active time for an active BWP to support functionalities inclusive of both SSSG switching and PDCCH skipping for a duration may be determined. The design for DCI based PDCCH monitoring adaptation that may support both SSSG switching and PDCCH skipping can also be achieved by introducing one or more of specific search space set groups. For example, the one or more of specific search space set groups may be an empty search space set group. That is, the search space set group may include no search space set or no monitoring occasion. When the UE switches SSSG ID to the one or more of specific search space set groups, no PDCCH monitoring occasions will be monitored by the UE, so that PDCCH skipping can be achieved. In other words, the UE may stop monitoring for the PDCCH(s) in response to no search space set or no monitoring occasion being included in the search space set group indicated to the UE.

In one embodiment, a plurality of search space set groups (e.g., two or more than two) may be configured to the UE via a configured information carried by a signalling such as an RRC message, wherein at least one of the search space set group in the plurality of search space set groups may be an empty search space set group (i.e. only common search space set belongs to the empty search space set group). After the plurality of search space set groups being configured to the UE, the UE may receive/decode/detect a first control information (e.g., first DCI) including one or more DCI fields relating to SSSG switching, wherein the one or more DCI fields may include a value indicating a search space set group configured to the UE, wherein the value may be a SS set group ID. The UE performs SSSG switching based on the one or more DCI fields (or the value included in the one or more DCI fields) relating to SSSG switching after a processing time (or an application delay).

More specifically, the UE may receive/decode/detect a second control information (e.g., second DCI) in a search space set with the SS set group ID based on the one or more DCI fields (or the value included in the one or more DCI fields) relating to SSSG switching. If the search space set group indicated by the one or more DCI fields relating to SSSG switching includes one or more search space sets, the UE may monitor for the PDCCH(s) in the one or more search space sets. On the other hand, if the search space set group indicated by the one or more DCI fields relating to SSSG switching is an empty search space set group (which only common search space set belongs to the empty search space set group), the UE may only monitor (configured) common SS set (groups) for the PDCCH(s) and may not monitor (configured) UE-specific SS set (groups) for the PDCCH(s). In other words, the UE may monitor a default search space set (group) according to the one or more DCI fields (or the value in the one or more DCI fields) relating to SSSG switching in response to no search space set being included in the search space set group indicated to the UE.

In one embodiment, a plurality of search space set groups (e.g., two or more than two) may be configured to the UE via a configured information carried by a signalling such as an RRC message, wherein at least one of the search space set group in the plurality of search space set groups may be an empty search space set group (i.e. no search space set belongs to the empty search space set group). After the plurality of search space set groups being configured to the UE, the UE may receive/decode/detect a first control information (e.g., first DCI) includes one or more DCI fields relating to SSSG switching, wherein the one or more DCI fields may include a value indicating a search space set group configured to the UE, wherein the value may be a SS set group identifier (ID). The UE performs SSSG switching based on the one or more DCI fields (or the value included in the one or more DCI fields) relating to SSSG switching after a processing time (or an application delay).

More specifically, if the search space set group indicated by the one or more DCI fields relating to SSSG switching includes one or more search space sets, the UE may monitor for the PDCCH(s) in the one or more search space sets. On the other hand, if the search space set group indicated by the one or more DCI fields relating to SSSG switching is an empty search space set group (i.e., no search space set belongs to the empty search space set group), the UE may not monitor (configured) UE-specific SS set (groups) for the PDCCH(s).

In one example, the first control information (e.g., first DCI) may be DCI format 0_1, DCI format 0_2, DCI format 1_1, DCI format 1_2, DCI format 2_0, and/or DCI format 2_6.

In one example, the one or more DCI fields relating to SSSG switching may be SCell dormancy field, and/or DCI field relating to search space set group switching flag.

In one example, the one or more DCI fields relating to SSSG switching may indicate information of at least one of SSSG ID, number of SS set groups, activation/deactivation of SSSG switching, cell groups for SSSG switching (e.g. cellGroupsForSwitchList), and timer (or period), wherein the timer may be used to indicate the (longest) period that the SSSG ID may be applied.

In one example, the processing time may be configured in RRC.

In one example, the UE may receive/decode/detect a second control information (e.g., second DCI) in a search space set with the SS set group ID based on the one or more DCI fields relating to SSSG switching. When the one or more DCI fields relating to SSSG switching indicating the empty search space set group, the UE may not monitor all configured SS sets (groups).

In one example, the empty search space set group may not be configured for SpCell (e.g., PCell and/or PSCell).

In one example, the UE may receive/decode/detect a second control information (e.g., second DCI) in a search space set with the SS set group ID based on the one or more DCI fields relating to SSSG switching. When the one or more DCI fields relating to SSSG switching indicating the empty search space set group, the UE may only monitor the SS sets (groups) that is not configured with an associated SSSG ID and may not monitor the other SS sets (groups). That is, the UE may only monitor the default SS sets (groups).

In one example, the UE may receive/decode/detect a second control information (e.g., second DCI) in a search space set with the SS set group ID based on the one or more DCI fields relating to SSSG switching. When the one or more DCI fields relating to SSSG switching indicating the empty search space set group, the UE may only monitor (configured) common SS set (groups) and may not monitor (configured) UE-specific SS set (groups).

In one example, the UE may receive/decode/detect a second control information (e.g., second DCI) in a search space set with the SS set group ID based on the one or more DCI fields relating to SSSG switching. When the one or more DCI fields relating to SSSG switching indicating the empty search space set group and/or the UE is performing some specific procedures (e.g., beam failure recovery procedure, random access procedure, and/or scheduling request), the UE may not switch/change the current SSSG ID (or the UE may ignore the one or more DCI fields relating to SSSG switching). The UE would have to monitor a search space set (e.g., a default search space set) while performing the specific procedures. In other words, if the search space set group configured to the UE includes no search space set or no monitoring occasion, the UE may stop monitoring for the PDCCH(s) in response to the event for the UE not occurring, or the UE may monitor for the PDCCH(s) in the default search space set in response to the event for the UE occurring, wherein the event may include a scheduling request, the random access procedure, and/or a beam failure recovery procedure.

In one example, the UE may receive/decode/detect a second control information (e.g., second DCI) in a search space set with the SS set group ID based on the one or more DCI fields relating to SSSG switching. When the one or more DCI fields relating to SSSG switching indicating the empty search space set group, the UE may not monitor configured SS sets (groups) for a specific time period (configured in RRC, and/or indicated by the one or more DCI fields relating to SSSG switching). The UE may continue to monitor the (configured) SS sets (groups) or default SS sets (groups) after the specific time period, the UE may start monitoring the (configured) SS sets (groups) or default SS sets (groups) after the specific time period, or the UE may continue to monitor the (configured) SS sets (groups) or default SS sets (groups) other than the empty search space set group after the specific time period. On the other hand, when the one or more DCI fields relating to SSSG switching indicating a search space set group including at least one configured SS set (group), the UE may monitor the configured SS set (group) for a specific time period (configured in RRC, and/or indicated by the one or more DCI fields relating to SSSG switching). The UE may continue to monitor the configured SS set (group) or may start monitor a default SS set (group) other than the configured SS set (group) after the specific time period.

In one implementation, n (n may be an integer greater than 2) SS set groups may be configured in RRC. One of the n SS set groups may be an empty SS set group. When the UE receives a DCI and the DCI field relating to SSSG switching indicates the UE to switch/change to the empty SS set group, the UE may not monitor all configured SS set (group), and/or the UE may not monitor all configured USS after a processing time. An empty SS set group applying period may be configured in RRC. A timer (which may be configured to the UE via RRC message) relating to the empty SS set group applying period may start after the processing time. When the timer expires, the UE may switch/change the SSSG ID to a default SSSG ID (which may be configured in RRC), and/or the UE may monitor a previous search space set corresponding to the SSSG ID, wherein the previous search space set is the search space set monitored by the UE before the timer starts (i.e., before the UE switches to the empty SS set group). On the other hand, when the UE receives a DCI and the DCI field relating to SSSG switching indicates the UE to switch/change to the configured SS set (group), the UE may monitor the configured SS set (group) after a processing time. A configured SS set group applying period may be configured in RRC. A timer (which may be configured to the UE via RRC message) relating to the configured SS set group applying period may start after the processing time. When the timer expires, the UE may switch/change the SSSG ID to a default SSSG ID (which may be configured in RRC). When the UE switched/changes to the default SSSG ID, the UE may start monitor the default SSSG corresponding to the SSSG ID.

In one implementation, n (n may be an integer greater than 2) SS set groups may be configured in RRC. One of the n SS set groups may be an empty SS set group. When the UE receives/detects a DCI and the DCI field relating to SSSG switching indicates the UE to switch/change to the empty SS set group, the UE does not monitor all configured USS after a processing time, and/or the UE may only monitor a specific SS set. The UE may not switch/change the SSSG ID until the UE monitor a DCI in CSS (or in the specific SS set) that indicating SSSG switching.

In one implementation, n (n may be an integer greater than 2) SS set groups may be configured in RRC. One of the n SS set groups may be an empty SS set group. In the condition when a UE receives/detects a DCI and the DCI field relating to SSSG switching indicates the UE to switch/change to the empty SS set group, the UE is performing a BFR procedure, and/or the contention-free Random Access Preamble for beam failure recovery request was transmitted by the UE, the UE may need to monitor the PDCCH(s) on the search space (set) indicated by recoverySearchSpaceId of the SpCell identified by the C-RNTI or MCS-C-RNTI, for example, while the ra-response window is running, regardless of the indication/control information of the DCI. Specifically, the UE may ignore the indication/control information of the DCI in this condition. Specifically, the indication/control information of the DCI may not be applicable in this condition.

In one implementation, n (n may be an integer greater than 2) SS set groups may be configured in RRC. One of the n SS set groups may be an empty SS set group. In the condition when a UE receives/detects a DCI and the DCI field relating to SSSG switching indicates the UE to switch/change to the empty SS set group, the UE is performing a SCell BFR procedure, and/or one or some specific MAC CE was transmitted by the UE, the UE may need to monitor the PDCCH(s), for example, when the SCell BFR MAC CE (or some specific MAC CE) is sent and the PDCCH (e.g., addressed to C-RNTI) indicating uplink grant for a new transmission was not received for the HARQ process used for the transmission of the SCell BFR MAC CE (or some specific MAC CE), regardless of the indication/control information of the PDCCH. Specifically, the UE may ignore the indication/control information of the DCI in this condition. Specifically, the indication/control information of the DCI may not be applicable in this condition.

In one implementation, n (n may be an integer greater than 2) SS set groups may be configured in RRC. One of the n SS set groups may be an empty SS set group. In the condition when a UE receives/detects a DCI and the DCI field relating to SSSG switching indicates the UE to switch/change to the empty SS set group, the UE is performing a RA procedure, and/or a RA preamble is transmitted, the UE may need to monitor the PDCCH(s) (e.g., on a search space (set) configured by RACH configuration), for RA response identified by the RA-RNTI, for example, while the ra-response window is running, regardless of the indication/control information of the DCI. Specifically, the UE may ignore the indication/control information of the DCI in this condition. Specifically, the indication/control information of the DCI may not be applicable in this condition. Specifically, in one example, the condition above does not include ra-response window is running.

In one implementation, two SS set groups are configured in RRC. One of the two SS set groups may be an empty SS set group. In the condition when a UE receives/detects a DCI and the DCI field relating to SSSG switching indicates the UE to switch/change to the empty SS set group, the UE is performing a RA procedure, and/or a Msg3 was transmitted by the UE, the UE may need to monitor the PDCCH(s) while the RA contention resolution timer is running, regardless of the indication/control information of the DCI. Specifically, the UE may ignore the indication/control information of the DCI in this condition. Specifically, the indication/control information of the DCI may not be applicable in this condition.

In one implementation, two SS set groups may be configured in RRC. One of the two SS set groups may be an empty SS set group. In the condition when a UE receives/detects a DCI and the DCI field relating to SSSG switching indicates the UE to switch/change to the empty SS set group and an SR is considered as pending, the UE may need to monitor the DCI, for example, when the SR is sent on PUCCH and is pending, regardless of the indication/control information of the DCI. Specifically, the UE may ignore the indication/control information of the DCI in this condition. Specifically, the indication/control information of the DCI may not be applicable in this condition.

In one implementation, two SS set groups may be configured in RRC. One of the two SS set groups may be an empty SS set group. In the condition when a UE receives/detects a DCI and the DCI field relating to SSSG switching indicates the UE to switch/change to the empty SS set group and a specific DRX timer is running, the UE may need to monitor the DCI, regardless of the indication/control information of the DCI. Specifically, the UE may ignore the indication/control information of the DCI in this condition. Specifically, the indication/control information of the DCI may not be applicable in this condition. The specific DRX timer may be drx-RetransmissionTimerDL and/or drx-RetransmissionTimerUL.

In one embodiment, when a DCI indicating at least one of SSSG switching, PDCCH skipping (for a duration), and SCell dormancy is not received/decoded/detected successfully by a UE, for example, on a specific CORESET/search space set, the UE behaviour on SSSG switching, PDCCH skipping for a duration, and SCell dormancy should be determined. More specifically, the search space sets may be configured to monitor PDCCH(s) for detection of a specific DCI format on the active DL BWP of the PCell or of the SpCell (e.g., according to a common search space). If a UE is provided with search space sets to monitor PDCCH(s) for detection of a specific DCI format in the active DL BWP of the PCell or of the SpCell and the UE does not detect the specific DCI format, the UE behaviour on SSSG switching, PDCCH skipping for a duration, and SCell dormancy should be determined.

In one example, the UE may not monitor the PDCCH(s) for detecting the DCI during Active Time.

In one example, the UE may not monitor the PDCCH(s) for detecting the DCI for all corresponding PDCCH monitoring occasions outside Active Time prior to a next long DRX cycle.

In one example, the UE may not monitor the PDCCH(s) for detecting the DCI during a measurement gap.

In one example, the UE may not monitor the PDCCH(s) for detecting the DCI when the MAC entity monitors for a PDCCH transmission on the search space indicated by recoverySearchSpaceId of the SpCell identified by the C-RNTI while the ra-ResponseWindow is running.

In one example, the UE may not monitor the PDCCH(s) for detecting the DCI when the UE is performing BWP switch.

In one embodiment, if a UE is configured to monitor a DCI relating to at least one of SSSG switching, PDCCH skipping for a duration, and SCell dormancy in one or more search space set(s) and the UE does not receive/decode/detect the DCI successfully, the UE may perform SSSG switching, PDCCH skipping (for a duration), and/or SCell dormancy operation according to one or more implementations as follows.

In one implementation, the UE may not perform SSSG switching (i.e. the UE may not change/switch the (current) SSSG ID).

In one implementation, the UE may be configured with a first timer (or a first period) by an RRC message. The first timer (or the first period) may be used to indicate the (longest) period that a SSSG ID may be applied, wherein the UE may monitor for the PDCCH(s) in a search space set group corresponding to the SSSG ID when the SSSG ID is applied. When the UE does not receive/decode/detect the DCI, the UE may not change/switch the (current) SSSG ID from the start of applying the SSSD ID until the first timer (or the first period) expires.

In one implementation, the UE may not change/switch the (current) SSSG ID after the first timer (or the first period) expires.

In one implementation, the UE may change to a default SSSG (SSSG may be configured by an RRC message) after the first timer (or the first period) expires.

In one implementation, the UE may not perform PDCCH skipping (i.e. the UE may always monitor search space set, and/or the UE may not skip any PDCCH monitoring).

In one implementation, the UE may not change the (current) PDCCH skipping duration.

In one implementation, the UE may be configured with a second timer (or a second period) by an RRC message. The second timer (or the second period) may be used to indicate the (longest) period that a PDCCH skipping duration may be applied. The UE may start the second timer (or the second period) when the UE start applying the (current) PDCCH skipping duration.

In one implementation, the second timer (or the second period) is not expected to be shorter (or less) than the (current) PDCCH skipping duration, wherein the PDCCH skipping duration may be indicated by the DCI.

In one implementation, the UE may always monitor search space set, and/or the UE may not skip any PDCCH monitoring after the second timer (or the second period) expires.

In one implementation, the UE may change to a default PDCCH skipping duration (PDCCH skipping duration may be configured by an RRC message) after the second timer (or the second period) expires.

In one implementation, the UE may not monitor any search space set after the second timer (or the second period) expires.

In one implementation, the first timer (or the first period) may be a same timer (or a same period) as the second timer (or the second period) in the RRC message.

In one embodiment, if a UE is configured to monitor a DCI relating to at least one of SSSG switching, PDCCH skipping for a duration, and SCell dormancy in one or more search space set(s) and the UE does not receive/decode/detect the DCI successfully, the UE may determine whether to perform SSSG switching, PDCCH skipping (for a duration), and/or SCell dormancy operation based on a configuration. For example, if the configuration indicates a first value (e.g., “0” or “1”), the UE may need to perform SSSG switching, PDCCH skipping (for a duration), and/or SCell dormancy operation if the UE does not receive/decode/detect the DCI successfully. For another example, if the configuration indicates a second value (e.g., “1” or “0”) different from the first value, the UE may not need to perform SSSG switching, PDCCH skipping (for a duration), and/or SCell dormancy operation if the UE does not receive/decode/detect the DCI successfully.

In one example, the DCI relating to at least one of SSSG switching, PDCCH skipping for a duration, and SCell dormancy may be DCI format 2_0, DCI format 2_6 in active time, and/or DCI format 2_6 outside active time.

In one example, the DCI relating to at least one of SSSG switching, PDCCH skipping for a duration, and SCell dormancy may be DCI format 1_1 without scheduling a PDSCH.

In one example, the UE may be configured with a specific timer (or a specific period) by an RRC message. The specific timer (or the specific period) may be used to indicate the (longest) period that one or more of parameters relating to PDCCH skipping, SSSG switching, and/or SCell dormancy may be applied.

In one implementation, a UE may be configured to monitor a DCI format 2_0 relating to SSSG switching. A default SSSG ID may be configured to the UE by an RRC message. A timer relating to SSSG switching may be configured to the UE. If the UE does not receive/decode/detect the DCI format 2_0 successfully, the UE may switch SSSG ID to the default SSSG ID until the timer relating to SSSG switching expires.

In one implementation, a UE may be configured to monitor a DCI format 2_6 outside active time relating to PDCCH skipping and SCell dormancy in an active time. If the UE does not receive/decode/detect the DCI format 2_6 successfully, the UE may not perform PDCCH skipping and SCell dormancy in the active time.

FIG. 7 illustrates a block diagram of a node for wireless communication according to an embodiment of the present disclosure. As shown in FIG. 7, a node 700 may include a transceiver 720, a processor 728, a memory 734, one or more presentation components 738, and at least one antenna 736. The node 700 may also include an RF spectrum band module, a base station communications module, a network communications module, and a system communications management module, Input/Output (I/O) ports, I/O components, and power supply (not explicitly shown in FIG. 7). Each of these components may be in communication with each other, directly or indirectly, over one or more buses 740. In one implementation, the node 700 may be a UE or a base station that performs various functions described herein, for example, with reference to FIG. 1 through FIG. 6.

The transceiver 720 having a transmitter 722 (e.g., transmitting/transmission circuitry) and a receiver 724 (e.g., receiving/reception circuitry) may be configured to transmit and/or receive time and/or frequency resource partitioning information. In some implementations, the transceiver 720 may be configured to transmit in different types of subframes and slots including, but not limited to, usable, non-usable and flexibly usable subframes and slot formats. The transceiver 720 may be configured to receive data and control channels.

The node 700 may include a variety of computer-readable media. Computer-readable media can be any available media that can be accessed by the node 700 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 734 may include computer-storage media in the form of volatile and/or non-volatile memory. The memory 734 may be removable, non-removable, or a combination thereof. Exemplary memory includes solid-state memory, hard drives, optical-disc drives, and etc. As illustrated in FIG. 7, the memory 734 may store computer-readable, computer-executable instructions 732 (e.g., software codes) that are configured to, when executed, cause the processor 728 to perform various functions described herein, for example, with reference to FIG. 1 through FIG. 6. Alternatively, the instructions 732 may not be directly executable by the processor 728 but be configured to cause the node 700 (e.g., when compiled and executed) to perform various functions described herein.

The processor 728 (e.g., having processing circuitry) may include an intelligent hardware device, e.g., a Central Processing Unit (CPU), a microcontroller, an ASIC, and etc. The processor 728 may include memory. The processor 728 may process the data 730 and the instructions 732 received from the memory 734, and information through the transceiver 720, the base band communications module, and/or the network communications module. The processor 728 may also process information to be sent to the transceiver 720 for transmission through the antenna 736, to the network communications module for transmission to a core network.

One or more presentation components 738 presents data indications to a person or other device. Exemplary presentation components 738 include a display device, speaker, printing component, vibrating component, and etc.

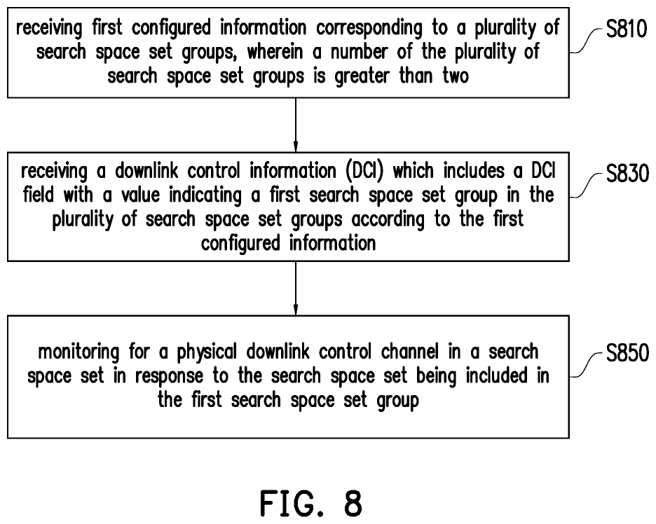

FIG. 8 illustrates a flowchart of a method of search space monitoring according to an embodiment of the present disclosure, wherein the method may be implemented by the UE as shown in FIG. 7. In step S810, receiving first configured information corresponding to a plurality of search space set groups, wherein a number of the plurality of search space set groups is greater than two. In step S830, receiving a downlink control information (DCI) which includes a DCI field with a value indicating a first search space set group in the plurality of search space set groups according to the first configured information. In step S850, monitoring for a physical downlink control channel in a search space set in response to the search space set being included in the first search space set group.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of search space monitoring, adapted to a user equipment, wherein the method comprising:
receiving first configured information corresponding to a plurality of search space set groups, wherein a number of the plurality of search space set groups is greater than two;
receiving a downlink control information (DCI) which includes a DCI field with a value indicating a first search space set group in the plurality of search space set groups according to the first configured information; and
monitoring for a physical downlink control channel in a search space set in response to the search space set being included in the first search space set group.

2. The method of claim 1, wherein one of the plurality of search space set groups includes no search space set or no monitoring occasion.

3. The method of claim 1, further comprising:
stopping monitoring for the physical downlink control channel in the search space set in response to no search space set or no monitoring occasion being included in the first search space set group.

4. The method of claim 3, wherein the step of stopping monitoring for the physical downlink control channel in the search space set in response to no search space set or no monitoring occasion being included in the first search space set group comprising:
stopping monitoring for the physical downlink control channel in the search space set in response to an event not occurring, wherein the event comprises one of a scheduling request, a random access procedure, and a beam failure recovery procedure.

5. The method of claim 1, further comprising:
monitoring a default search space set according to the value in response to no search space set being included in the first search space set group.

6. The method of claim 5, wherein the step of monitoring the default search space set according to the value in response to no search space set being included in the first search space set group comprising:
monitoring the default search space set in response to an event occurring, wherein the event comprises one of a scheduling request, a random access procedure, and a beam failure recovery procedure.

7. The method of claim 1, further comprising:
receiving second configured information corresponding to a timer; and
monitoring for the physical downlink control channel in the search space set while the timer is running.

8. The method of claim 7, further comprising:
starting monitoring for the physical downlink control channel in a default search space set after the timer expiring.

9. The method of claim 1, wherein a format of the downlink control information comprises one of downlink control information 0_1, downlink control information 0_2, downlink control information 1_1, and downlink control information 1_2.

10. The method of claim 1, wherein the downlink control information further includes a number of search space set groups.

11. A user equipment, comprising:
one or more non-transitory computer-readable media having computer-executable instructions embodied thereon; and
at least one processor coupled to the one or more non-transitory computer-readable media, and configured to execute the computer-executable instructions to:
receive first configured information corresponding to a plurality of search space set groups, wherein a number of the plurality of search space set groups is greater than two;
receive a downlink control information (DCI) which includes a DCI field with a value indicating a first search space set group in the plurality of search space set groups according to the first configured information; and
monitor for a physical downlink control channel in a search space set in response to the search space set being included in the first search space set group.

12. The user equipment of claim 11, wherein one of the plurality of search space set groups includes no search space set or no monitoring occasion.

13. The user equipment of claim 11, wherein the at least one processor further configured to execute the computer-executable instructions to:
stop monitoring for the physical downlink control channel in the search space set in response to no search space set or no monitoring occasion being included in the first search space set group.

14. The user equipment of claim 13, wherein the at least one processor further configured to execute the computer-executable instructions to:
stop monitoring for the physical downlink control channel in the search space set in response to an event not occurring, wherein the event comprises one of a scheduling request, a random access procedure, and a beam failure recovery procedure.

15. The user equipment of claim 11, wherein the at least one processor further configured to execute the computer-executable instructions to:
monitor a default search space set according to the value in response to no search space set being included in the first search space set group.

16. The user equipment of claim 15, wherein the at least one processor further configured to execute the computer-executable instructions to:
monitor the default search space set in response to an event occurring, wherein the event comprises one of a scheduling request, a random access procedure, and a beam failure recovery procedure.

17. The user equipment of claim 11, wherein the at least one processor further configured to execute the computer-executable instructions to:
receive second configured information corresponding to a timer; and
monitor for the physical downlink control channel in the search space set while the timer is running.

18. The user equipment of claim 17, wherein the at least one processor further configured to execute the computer-executable instructions to:
start monitoring for the physical downlink control channel in a default search space set after the timer expiring.

19. The user equipment of claim 11, wherein a format of the downlink control information comprises one of downlink control information 0_1, downlink control information 02, downlink control information 1_1, and downlink control information 1_2.

20. The user equipment of claim 11, wherein the downlink control information further includes a number of search space set groups.
